(19) United States
(12) Patent Application Publication
(10) Pub. No.: US 2026/0268477 A1
(43) Pub. Date: Sep. 10, 2026

(54) SYSTEM AND METHOD FOR NUTRITIONAL ANALYSIS OF STRAW FEED BASED ON IMAGE RECOGNITION

(71) Applicant: Guizhou University, Guiyang (CN)

(72) Inventors: Jun Hao, Guiyang (CN); Hailong Yang, Guiyang (CN); Bing Tian, Guiyang (CN); Xiaona Lu, Guiyang (CN); Ke Liu, Guiyang (CN); Fuyu Yang, Guiyang (CN); Chao Chen, Guiyang (CN)

(21) Appl. No.: 19/369,387

(22) Filed: Oct. 27, 2025

(30) Foreign Application Priority Data
Mar. 5, 2025 (CN) 202510252580.1

(51) Int. Cl. G06T 7/00; G06T 7/11; G06V 10/75; G06V 20/68

(52) U.S. Cl. CPC G06T 7/001; G06T 7/11; G06V 10/758; G06V 20/68; G06T 2207/30128

(57) ABSTRACT

Provided are a system and method for nutritional analysis of straw feed based on image recognition. The method includes: performing multi-directional optical imaging acquisition on a surface of a straw to obtain straw image data, and dividing the straw image data into analysis sub-regions; performing morphological analysis to extract fiber arrangement information, and extracting fiber micro-difference indicators; performing complexity analysis on distribution characteristics of the fiber micro-difference indicators, to determine whether randomness of a fiber arrangement pattern of the straw is normal to thereby obtain a first determination result; analyzing a variation trend of the fiber micro-difference indicators, to determine whether a deviation amplitude of a fiber arrangement of the straw is normal to thereby obtain a second determination result; determining whether a stability of the fiber micro-difference indicators meets a preset requirement; comparing the fiber micro-difference indicators with fiber composition reference data; and determining straw nutrition analysis data.

### CROSS-REFERENCE TO RELATED APPLICATION

This application claims the priority of Chinese Patent Application No. 202510252580.1, filed on Mar. 5, 2025, which is herein incorporated by reference in its entirety.

### TECHNICAL FIELD

The present disclosure relates to the field of image analysis technologies, and particularly to a system and method for nutritional analysis of straw feed based on image recognition.

### BACKGROUND

In the production and application of straw feed, accurate assessment of fibrous nutritional components of the straw feed is a key basis for determining a feeding value of the straw feed. At present, most techniques evaluate nutrition by directly detecting principal constituents (e.g., cellulose, hemicellulose, lignin) of the straw fiber. However, these techniques typically rely on chemical assays or simple surface-texture image processing, overlooking microscopic, subtle differences in a fiber arrangement. Yet straw from different sources or subjected to different treatments may exhibit complex variations in fiber arrangement patterns and distribution regularities. Such subtle differences are often difficult to capture effectively with existing methods, yet they significantly impact the accuracy of nutritional assessment, particularly when there are substantial differences between batches.

In a related art, there is no efficient way to recognize and evaluate these subtle differences in straw fiber arrangement, resulting in insufficient accuracy and stability of nutritional-component analyses.

### SUMMARY

To overcome the above-mentioned shortcomings of the related art, embodiments of the present disclosure provide a system and method for nutritional analysis of straw feed based on image recognition, so as to solve the problems set forth in the background.

To achieve the above objective, the present disclosure provides the following technical solutions.

In a first aspect, a method for nutritional analysis of straw feed based on image recognition is provided, which includes:
performing multi-directional optical imaging acquisition on a surface of a straw to obtain straw image data, and dividing the straw image data into multiple analysis sub-regions;
performing morphological analysis to extract fiber arrangement information from the multiple analysis sub-regions to enhance fiber texture features, and extracting fiber micro-difference indicators based on pixel distribution parameters and neighborhood relationships of the fiber arrangement information;
performing complexity analysis on distribution characteristics of the fiber micro-difference indicators through image decomposition based on a multifractal model, to determine whether randomness of a fiber arrangement pattern of the straw within a local region is normal to thereby obtain a first determination result;
analyzing a variation trend of the fiber micro-difference indicators over different time sequences by using a nonlinear method based on phase space reconstruction, to determine whether a deviation amplitude of a fiber arrangement of the straw is normal to thereby obtain a second determination result;
determining, based on the first determination result and the second determination result, whether a stability of the fiber micro-difference indicators meets a preset requirement; and
in response to the stability of the fiber micro-difference indicators meeting the preset requirement, comparing the fiber micro-difference indicators with fiber composition reference data to determine whether the fiber micro-difference indicators meet a preset standard; and in response to determining that the fiber micro-difference indicators meet a preset standard, determining nutrition analysis data of the straw.

In an embodiment, the performing multi-directional optical imaging acquisition on a surface of a straw to obtain straw image data, and dividing the straw image data into multiple analysis sub-regions includes:
arranging multiple optical imaging devices on the surface of the straw, and configuring multiple sets of light sources, and obtaining the straw image data from multiple directions by adjusting focal lengths and shooting parameters of the multiple optical imaging devices; and
storing and pre-processing the straw image data from the multiple directions to obtain a preprocessed image set, and decomposing the preprocessed image set into the multiple analysis sub-regions according to a preset division criterion.

In an embodiment, the performing morphological analysis to extract fiber arrangement information from the multiple analysis sub-regions to enhance fiber texture features, and extracting fiber micro-difference indicators based on pixel distribution parameters and neighborhood relationships of the fiber arrangement information, includes:
performing the morphological analysis on the straw image data within the multiple analysis sub-regions, and enhancing the fiber texture features by selecting multi-scale structural elements, wherein the multi-scale structural elements are configured to adapt to fiber textures of different thicknesses and orientations;
performing quantitative analysis on the fiber arrangement information in the multiple analysis sub-regions based on the pixel distribution parameters, wherein the pixel distribution parameters are obtained by calculating gray value variation characteristics of the local region;
analyzing, based on spatial correlation between local pixels and surrounding pixels of the local pixels, the neighborhood relationships of the fiber arrangement information to extract neighborhood characteristic parameters of the fiber arrangement of the straw; and
extracting the fiber micro-difference indicators based on the pixel distribution parameters and the neighborhood characteristic parameters, wherein the fiber micro-difference indicators are used to characterize micro-difference characteristics of the fiber arrangement of the straw.

In an embodiment, the performing complexity analysis on distribution characteristics of the fiber micro-difference indicators through image decomposition based on a multifractal model, to determine whether randomness of a fiber arrangement pattern of the straw within a local region is normal to thereby obtain a first determination result, includes:
generating a two-dimensional distribution matrix based on a spatial coordinate distribution of the fiber micro-difference indicators in the multiple analysis sub-regions;
decomposing, based on the multifractal model, the two-dimensional distribution matrix into multiple scale components;
calculating fractal dimensions respectively corresponding to the multiple scale components to quantify complexities of the fiber arrangement at different scales in the two-dimensional distribution matrix;
extracting complexity characteristic parameters for characterizing the randomness of the fiber arrangement pattern according to a distribution pattern of the fractal dimensions across the different scales, wherein the complexity characteristic parameters comprise a fractal spectrum width and a fractal intensity; and
comparing the complexity characteristic parameters with a preset standard to determine whether the randomness of the fiber arrangement pattern within the local region is normal.

In an embodiment, the analyzing a variation trend of the fiber micro-difference indicators over different time sequences by using a nonlinear method based on phase space reconstruction, to determine whether a deviation amplitude of a fiber arrangement of the straw is normal to thereby obtain a second determination result, includes:
arranging the fiber micro-difference indicators corresponding to multiple time points in a preset order to form a fiber micro-difference indicator time series;
mapping the fiber micro-difference indicator time series to a multi-dimensional state vector set based on the phase space reconstruction;
performing a nonlinear analysis method on the multi-dimensional state vector set to extract deviation-related characteristic parameters, wherein the deviation-related characteristic parameters are used to quantify a variation pattern of the fiber arrangement in a time dimension; and
comparing the deviation-related characteristic parameters with a preset reference range to determine whether the deviation amplitude of the fiber arrangement of the straw is normal.

In an embodiment, the performing a nonlinear analysis method on the multi-dimensional state vector set to extract deviation-related characteristic parameters, where the deviation-related characteristic parameters are used to quantify a variation pattern of the fiber arrangement in a time dimension, includes:
calculating a Euclidean distance between state vectors corresponding to adjacent time points as a local deviation distance based on the following formula:

$$B ( t ) = \sqrt{{\sum }_{a = 1}^{A} {( {V}_{a} ( t ) - {V}_{a} ( t - 1 ) )}^{2}}$$

where B(t) represents a local deviation distance at a time point t, Vₐ(t) represents a a-th component of a state vector at time point t, a represents an index of a component in the state vector, and A represents an embedding dimension.

In an embodiment, the determining, based on the first determination result and the second determination result, whether a stability of the fiber micro-difference indicators meets a preset requirement, includes:
in response to that the randomness of the fiber arrangement pattern of the straw within the local region is normal and the deviation amplitude of the fiber arrangement of the straw is normal, determining the stability of the fiber micro-difference indicators meeting the preset requirement; otherwise, determining the stability of the fiber micro-difference indicators not meeting the preset requirement.

In an embodiment, the in response to the stability of the fiber micro-difference indicators meeting the preset requirement, comparing the fiber micro-difference indicators with fiber composition reference data to determine whether the fiber micro-difference indicators meet a preset standard; and in response to determining that the fiber micro-difference indicators meet the preset standard, determining nutrition analysis data of the straw, includes:
selecting reference data respectively corresponding to the multiple analysis sub-regions from a preset fiber composition reference database according to attributes of the multiple analysis sub-regions;
comparing the fiber micro-difference indicators in the multiple analysis sub-regions with the selected reference data respectively corresponding to the multiple analysis sub-regions item by item to determine each of the fiber micro-difference indicators meet the preset standard;
in response to all of the fiber micro-difference indicators meet the preset standard, generating the nutrition analysis data of the straw.

In a second aspect, a system for nutritional analysis of straw feed based on image recognition is provided, which includes:
an optical imaging acquisition module, configured to: perform multi-directional optical imaging acquisition on a surface of a straw to obtain straw image data, and divide the straw image data into multiple analysis sub-regions;
a fiber micro-difference extraction module, configured to: perform morphological analysis to extract fiber arrangement information from the multiple analysis sub-regions to enhance fiber texture features, and extract fiber micro-difference indicators based on pixel distribution parameters and neighborhood relationships of the fiber arrangement information;
a randomness complexity analysis module, configured to: perform complexity analysis on distribution characteristics of the fiber micro-difference indicators through image decomposition based on a multifractal model, to determine whether randomness of a fiber arrangement pattern of the straw within a local region is normal to thereby obtain a first determination result;
a deviation amplitude analysis module, configured to: analyze a variation trend of the fiber micro-difference indicators over different time sequences by using a nonlinear method based on phase space reconstruction, to determine whether a deviation amplitude of a fiber arrangement of the straw is normal to thereby obtain a second determination result;
a stability comprehensive determination module, configured to: determine, based on the first determination result and the second determination result, whether a stability of the fiber micro-difference indicators meets a preset requirement; and
a nutrition data generation module, configured to: in response to the stability of the fiber micro-difference indicators meeting the preset requirement, compare the fiber micro-difference indicators with fiber composition reference data to determine whether the fiber micro-difference indicators meet a preset standard; and in response to determining that the fiber micro-difference indicators meet the preset standard, determine nutrition analysis data of the straw.

The system and method for nutritional analysis of straw feed based on image recognition provided in the embodiments of the present disclosure has at least the following technical effects and advantages.

1. Multi-dimensional texture information of the surface of the straw can be recorded comprehensively by multi-directional optical imaging acquisition technology, which provides high-quality data input for subsequent analysis. Morphological analysis combined with multi-scale structural elements can effectively enhance the fiber texture characteristics and make the microscopic differences more prominent. Further, based on the complexity analysis of the multifractal model and the dynamic analysis of phase space reconstruction, the dynamic characteristics of the fiber arrangement can be accurately evaluated from the two dimensions of randomness and deviation amplitude, respectively, to ensure that the extracted fiber micro-difference indicators can fully reflect the microscopic characteristics of fibers of the straw.

2. By comparing the fiber micro-difference indicators with the fiber component reference data item by item, the matching degree between the fiber arrangement characteristics and the preset standard can be accurately determined, and the high-precision evaluation of straw nutritional components (i.e., nutrition analysis data of the straw) can be realized. Especially for the straw samples from different sources or different processing batches, the accuracy and consistency of nutritional evaluation are significantly improved through the dual mechanism of stability determination and data comparison. Compared with the traditional chemical analysis method, it can not only realize nondestructive testing, but also quickly process large-scale samples, significantly improving the analysis efficiency, and at the same time optimizing the feed formula and the production process.

### BRIEF DESCRIPTION OF DRAWINGS

FIG. 1 illustrates a flow chart of a method for nutritional analysis of straw feed based on image recognition according to an embodiment 1 of the present disclosure.

FIG. 2 illustrates a schematic structural view of a system for nutritional analysis of straw feed based on image recognition according to an embodiment 2 of the present disclosure.

### DETAILED DESCRIPTION OF EMBODIMENTS

The technical solutions in the embodiments of the present disclosure will be described clearly and completely below in conjunction with the accompanying drawings. Apparently, the described embodiments are only a part of the embodiments of the present disclosure, rather than all of them. Based on the embodiments of the present disclosure, all other embodiments obtained by those of ordinary skill in the art without making creative efforts shall fall within the protection scope of the present disclosure.

### Embodiment 1

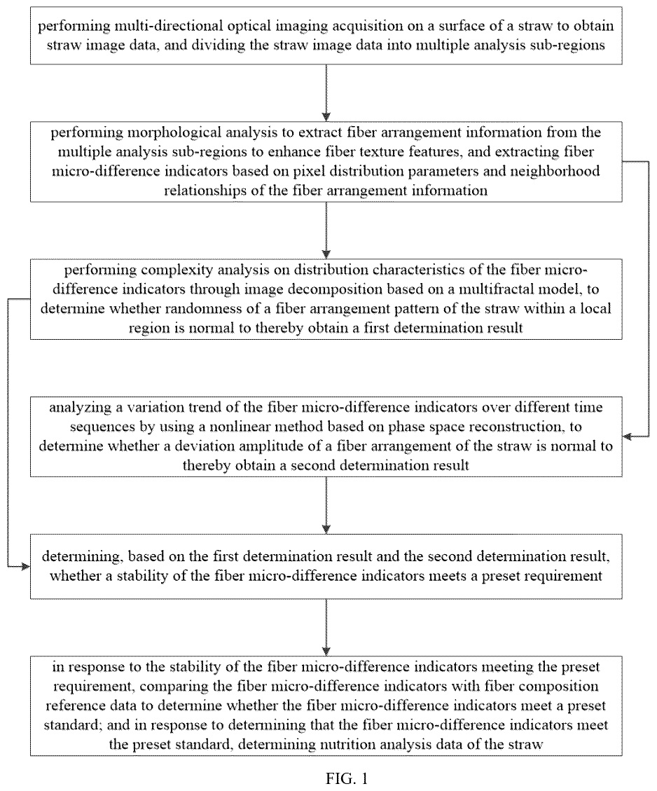

FIG. 1 illustrates a flow chart of a method for nutritional analysis of straw feed based on image recognition according to an embodiment 1 of the present disclosure, which includes the following steps:
performing multi-directional optical imaging acquisition on a surface of a straw to obtain straw image data, and dividing the straw image data into multiple analysis sub-regions;
performing morphological analysis to extract fiber arrangement information from the multiple analysis sub-regions to enhance fiber texture features, and extracting fiber micro-difference indicators based on pixel distribution parameters and neighborhood relationships of the fiber arrangement information;
performing complexity analysis on distribution characteristics of the fiber micro-difference indicators through image decomposition based on a multifractal model, to determine whether randomness of a fiber arrangement pattern of the straw within a local region is normal to thereby obtain a first determination result;
analyzing a variation trend of the fiber micro-difference indicators over different time sequences by using a nonlinear method based on phase space reconstruction, to determine whether a deviation amplitude of a fiber arrangement of the straw is normal to thereby obtain a second determination result;
determining, based on the first determination result and the second determination result, whether a stability of the fiber micro-difference indicators meet a preset requirement; and
in response to the stability of the fiber micro-difference indicators meeting the preset requirement, comparing the fiber micro-difference indicators with fiber composition reference data to determine whether the fiber micro-difference indicators meet a preset standard; and in response to determining that the fiber micro-difference indicators meet the preset standard, determining nutrition analysis data of the straw.

In an embodiment, the multifractal model is software configured to be stored in at least one memory and executable by at least one processor coupled to the at least one memory.

In an embodiment, the performing multi-directional optical imaging acquisition on a surface of a straw to obtain straw image data, and dividing the straw image data into multiple analysis sub-regions includes:
arranging multiple optical imaging devices on the surface of the straw, and configuring multiple sets of light sources, and obtaining the straw image data from multiple directions by adjusting focal lengths and shooting parameters of the multiple optical imaging devices; and
storing and pre-processing the straw image data from the multiple directions to obtain a preprocessed image set, and decomposing the preprocessed image set into the multiple analysis sub-regions according to a preset division criterion.

Specifically, in the process for arranging the multiple optical imaging devices on the surface of the straw, and configuring the multiple sets of light sources, and obtaining the straw image data from the multiple directions by adjusting the focal lengths and shooting the parameters of the multiple optical imaging devices, the multiple optical imaging device shall be configured to capture multi-view data of the surface of the straw from the multiple directions so that fiber texture features of the surface of the straw are recorded comprehensively. The multiple sets of light sources are arranged so that light reaches the surface of the straw from every required angle, thereby eliminating shadows and raising image clarity and contrast.

The focal lengths of the multiple optical imaging device are adjusted in accordance with surface properties and texture of the straw to secure high-resolution image data, especially for fine fiber structures and surface irregularities. The shooting parameters such as exposure time, shutter speeds and gains are set to stabilize image acquisition under varying ambient conditions and to guarantee consistent image quality.

Specifically, in the process for storing and pre-processing the straw image data from the multiple directions to obtain the preprocessed image set, and decomposing the preprocessed image set into the multiple analysis sub-regions according to the preset division criterion, the straw image data captured from the multiple directions is stored, and the straw image data is organized into the preprocessed image set. The preprocessed image set contains images of the straw taken from different angles, guaranteeing comprehensive coverage of the surface.

Further, denoising is performed on the images to remove noise, enhance clarity, and carry out color/brightness correction so that the images are ready for downstream processing.

According to the preset division criterion—such as a continuity of fiber structures and a homogeneity of image content, the preprocessed image set is decomposed into independent analysis sub-regions. Each of the analysis sub-regions must be both representative and self-contained, reflecting distinct fibrous structural units of the straw.

The preset dividing criterion is a standard based on the fiber arrangement characteristics, image texture characteristics and regional uniformity of the surface of the straw, which is used to divide the preprocessed image set into the multiple analysis sub-regions. Specifically, the preset dividing criterion includes: based on the continuity of fiber texture, when the texture features maintain a high correlation or consistency in certain areas, the certain areas are divided into the same sub-area; based on a change of color gradient, when a brightness or color distribution of a local area changes in a certain range, the local area is divided into independent sub-regions. For example, for a straw surface image, if arrangement directions of some fibers are basically the same and the color gradient of some fibers is relatively stable, it can be used as an analysis sub-region. In another part of the image, if the fiber shows obvious direction change or color transition, it should be divided into new analysis sub-regions. This division ensures that each sub-region is consistent in characteristics, which is convenient for subsequent fiber arrangement information extraction and analysis.

The surface of the straw refers to a surface of the straw feed. Acquisition methods for the surface of the straw include but are not limited to sampling from straw feed, ensuring representativeness and diversity by randomly sampling or selecting straw feed samples in batches. After sampling, a relatively complete part of the surface can be directly selected for analysis, or the surface of the sample can be cleaned to eliminate the influence of external pollutants and provide reliable surface conditions for subsequent optical imaging acquisition.

In an embodiment, the performing morphological analysis to extract fiber arrangement information from the multiple analysis sub-regions to enhance fiber texture features, and extracting fiber micro-difference indicators based on pixel distribution parameters and neighborhood relationships of the fiber arrangement information, includes:
performing the morphological analysis on the straw image data within the multiple analysis sub-regions, and enhancing the fiber texture features by selecting multi-scale structural elements, wherein the multi-scale structural elements are configured to adapt to fiber textures of different thicknesses and orientations;
performing quantitative analysis on the fiber arrangement information in the multiple analysis sub-regions based on the pixel distribution parameters, wherein the pixel distribution parameters are obtained by calculating gray value variation characteristics of the local region;
analyzing, based on spatial correlation between local pixels and surrounding pixels of the local pixels, the neighborhood relationships of the fiber arrangement information to extract neighborhood characteristic parameters of the fiber arrangement of the straw; and
extracting the fiber micro-difference indicators based on the pixel distribution parameters and the neighborhood characteristic parameters, wherein the fiber micro-difference indicators are used to characterize micro-difference characteristics of the fiber arrangement of the straw.

Specifically, in the process for performing the morphological analysis on the straw image data within the multiple analysis sub-regions, and enhancing the fiber texture features by selecting multi-scale structural elements, for each analysis sub-region in the straw image data, morphological analysis is applied to enhance the fiber texture features. A core of morphological analysis lies in the use of the multi-scale structural elements to process the fiber textures. These multi-scale structural elements are geometric primitives defined by specific size and shape parameters, designed to adapt to fibers of varying thicknesses and orientations within the analysis sub-regions.

It is assumed that an analysis sub-region in the straw image data is represented as I(x, y), where x and y are horizontal and vertical coordinates of the image, respectively. The morphological operation is applied to I(x, y) according to the following formula:

$${I}^{′} ( x , y ) = {{⋃}_{s = 1}}^{n} {{⋂}_{k = 1}}^{m} [ I ( x , y ) ∘ {E}_{s , k} ]$$

where I′(x, y) represents morphologically enhanced image data; E_{s,k} represents a multi-scale structural element; s represents a scale of the multi-scale structural element, with a value range of s∈1, n; k represents an orientation parameter, with a value range of k∈[1, m]; n represents a number of scales for the multi-scale structural element, and m represents a number of orientations; ∘ represents a morphological opening or closing operation, used for denoising and enhancing fiber textures.

By applying the morphological operations to I(x, y), fiber texture features at different scales and orientations can be enhanced, ensuring that the fiber arrangement information in the analysis sub-regions is fully preserved.

Specifically, in the process for performing quantitative analysis on the fiber arrangement information in the multiple analysis sub-regions based on the pixel distribution parameters, for the morphologically enhanced image data, pixel distribution parameters are extracted based on characteristics of pixel gray-level distribution to quantitatively analyze local variations in the fiber arrangement information. These pixel distribution parameters are calculated based on gray-level variations within the local regions, reflecting the density and uniformity of fiber textures.

For example, within an analysis sub-region, a local window is selected with its center pixel coordinates at (p, q) and a window size of l×l. The pixel distribution parameter is defined as:

$$D ( p , q ) = \frac{1}{{l}^{2}} {\sum }_{i = 1}^{l} {\sum }_{j = 1}^{l} \vert {I}^{′} ( p + i , q + j ) - {I}^{′} ( p , q ) \vert$$

where D(p, q) represents the pixel distribution parameter at a center point of the window; I′(p+i, q+j) represents a gray-level value of a pixel in the window; I′(p, q) represents a gray-level value of the center in the window; l represents a side length of the window; i represents a horizontal offset of a current pixel in the local window relative to a upper left corner of the local window, which is used to traverse each pixel of the window; j represents a vertical offset of the current pixel in the local window relative to an upper left corner of the window, which is used to traverse each pixel of the window; q represents the vertical coordinate of the central pixel of the local window, which is used to locate the specific position of the window in the image; and p represents a horizontal coordinate of the central pixel of the local window, which is used to locate the specific position of the window in the image.

The size of the pixel distribution parameter reflects the intensity of gray-scale change of fiber arrangement, including: the larger parameter indicates that the gray-scale value of fiber arrangement changes sharply in local areas, which may indicate uneven fiber distribution or prominent texture differences; Small parameter: It indicates that the change of gray value in local area is relatively smooth, which may indicate that the fiber distribution is relatively uniform or the texture characteristics are weak.

By calculating the pixel distribution parameters of all window center points in each analysis sub-area, the gray-scale variation characteristics of fiber arrangement are quantified. By calculating the pixel distribution parameters of each window center point, the pixel distribution parameters corresponding to all window center points in the analysis sub-area can be aggregated to form a pixel distribution characteristic map in the area, which reflects the gray-scale variation trend of fiber arrangement in local areas, including the distribution of high-gray variation areas and low-gray variation areas, thus quantifying the density and uniformity characteristics of fiber arrangement.

Specifically, in the process for analyzing, based on spatial correlation between local pixels and surrounding pixels of the local pixels, the neighborhood relationships of the fiber arrangement information to extract neighborhood characteristic parameters of the fiber arrangement of the straw, based on spatial correlation characteristics between pixels, the neighborhood feature parameters of the fiber arrangement information are extracted. The neighborhood relationship is used to reflect the structural consistency and spatial distribution characteristics of the pixels within the local regions.

A neighborhood feature parameter for a pixel point is defined as:

$$R ( p , q ) = \frac{1}{Z} {\sum }_{z = 1}^{Z} [ {I}^{′} ( p , q ) \cdot {I}^{′} ( p + Δ {x}_{z} , q + Δ {y}_{z} ) ]$$

where R(p, q) represents a neighborhood characteristic parameter of a pixel, Z represents a total number of pixels in the neighborhood, z represents a serial number of the current pixel in the neighborhood, and Δx_{z} and Δy_{z} represent a horizontal offset and a vertical offset of a z-th pixel relative to the center point (p, q), respectively.

The size of neighborhood characteristic parameters reflects the local spatial correlation of fiber arrangement, including: the larger parameter indicates that the correlation between pixel point and its neighboring pixels is strong, indicating that fiber arrangement has high consistency and coherence; the small parameter indicates that the correlation between a pixel and its neighboring pixels is weak, indicating that the fiber arrangement may be discrete or random.

Specifically, in the process for extracting the fiber micro-difference indicators based on the pixel distribution parameters and the neighborhood characteristic parameters, wherein the fiber micro-difference indicators are used to characterize micro-difference characteristics of the fiber arrangement of the straw, after completing the extraction of the pixel distribution parameters and the neighborhood feature parameters, the pixel distribution parameters and the neighborhood feature parameters are combined to generate the micro-difference indicators. The micro-difference indicators are used to characterize the microscopic variation properties of the fiber arrangement.

A micro-difference indicator is defined as: F=α·D+β·R, where F represents a fiber micro-difference indicator, D represents an average value of the pixel distribution parameters, R represents an average value of the neighborhood characteristic parameters, a and β represent weights of the pixel distribution parameters and the neighborhood characteristic parameters respectively, and α and β are greater than 0. The micro-difference indicator comprehensively incorporates both the pixel distribution parameter and the neighborhood feature parameter to characterize the microscopic differences in fiber arrangement.

Fiber differential indicator integrates the pixel distribution parameters and the neighborhood characteristic parameters, and is used to characterize the microscopic differential characteristics of fiber arrangement. A large fiber differential indicator indicates that the fiber arrangement in the analysis sub-region is significantly different, which may be manifested as the randomness of fiber arrangement is enhanced or the local correlation is low, usually reflecting the uneven distribution of fibers or high arrangement complexity; The small fiber differential indicator indicates that the fiber arrangement difference in the analysis sub-region is low, and the fiber distribution tends to be uniform and has high consistency.

Specifically, the weights of the pixel distribution parameters and the neighborhood characteristic parameters determine the composition ratio of fiber differential indicators, and the weight setting needs to be adjusted according to specific analysis requirements. If more attention is paid to gray level change, the weight of pixel distribution parameters should be increased. if more attention is paid to spatial correlation, the weight of neighborhood characteristic parameters is increased to optimize the accuracy of evaluating fiber arrangement characteristics.

In an embodiment, the performing complexity analysis on distribution characteristics of the fiber micro-difference indicators through image decomposition based on a multifractal model, to determine whether randomness of a fiber arrangement pattern of the straw within a local region is normal to thereby obtain a first determination result, includes:
generating a two-dimensional distribution matrix based on a spatial coordinate distribution of the fiber micro-difference indicators in the multiple analysis sub-regions;
decomposing, based on the multifractal model, the two-dimensional distribution matrix into multiple scale components;
calculating fractal dimensions respectively corresponding to the multiple scale components to quantify complexities of the fiber arrangement at different scales in the two-dimensional distribution matrix;
extracting complexity characteristic parameters for characterizing the randomness of the fiber arrangement pattern according to a distribution pattern of the fractal dimensions across the different scales, wherein the complexity characteristic parameters comprise a fractal spectrum width and a fractal intensity; and
comparing the complexity characteristic parameters with a preset standard to determine whether the randomness of the fiber arrangement pattern within the local region is normal.

Specifically, in the process for generating a two-dimensional distribution matrix based on a spatial coordinate distribution of the fiber micro-difference indicators in the multiple analysis sub-regions, within the analysis sub-region, the micro-difference indicator of each pixel is spatially organized to generate a corresponding two-dimensional distribution matrix based on the spatial coordinates of the pixels. Each element in the matrix corresponds to the micro-difference indicator value of a pixel, and the number of rows and columns in the matrix corresponds to the height and width of the image, respectively.

To ensure the accuracy of matrix generation, it is essential to guarantee that the calculated micro-difference indicator covers all pixels in each sub-region. Areas that have not been calculated are marked as missing values. Furthermore, data interpolation methods are applied to fill any gaps caused by acquisition errors, ensuring the completeness of the matrix.

Specifically, in the process for decomposing, based on the multifractal model, the two-dimensional distribution matrix into multiple scale components, the generated two-dimensional distribution matrix is decomposed using a multifractal model to extract features at different scales. The specific operations include: decomposing the two-dimensional distribution matrix into several sub-matrices with distinct scale characteristics, where each sub-matrix corresponds to a specific decomposition scale. The decomposition process adheres to the hierarchical principle of the multifractal model, which involves gradually extracting fine-scale features by reducing the size of the observation window while preserving global macroscopic features.

Each decomposed sub-matrix retains the distribution characteristics of the original data at its corresponding scale and is used for subsequent complexity analysis.

In the process for calculating fractal dimensions respectively corresponding to the multiple scale components to quantify complexities of the fiber arrangement at different scales in the two-dimensional distribution matrix, a formula for calculating the fractal dimension is expressed as follows:

$${D}_{f} = {lim}_{r \to 0} \frac{log N ( r )}{log ( 1 / r )}$$

where D_{f} represents a fractal dimension, which is used to measure the complexity of data distribution at the current scale; N(r) represents a number of feature points covered by a submatrix with a scale of r; and r represents a scale size of a current observation window.

The fractal dimension reflects the hierarchical complexity of fiber arrangement, and the higher fractal dimension indicates that the matrix data has more randomness and diversity.

Specifically, in the process for extracting complexity characteristic parameters for characterizing the randomness of the fiber arrangement pattern according to a distribution pattern of the fractal dimensions across the different scales, a changing trend of the fractal dimensions on each scale, such as whether it presents monotonic decreasing, oscillating or disordered distribution, is analyzed; parameters such as fractal spectrum width and fractal intensity are extracted as complexity characteristic parameters to express the complexity of fiber arrangement.

Fractal spectral width refers to the variation range of fractal dimension in different scale components, which is used to quantify the diversity of data distribution. Fractal spectral width is calculated by statistical analysis of the difference between the maximum and minimum values of fractal dimension. A larger fractal spectral width indicates that fiber arrangement has wider multi-scale characteristics, and there may be complex random distribution and significant non-uniformity, while a smaller fractal spectral width indicates that the distribution characteristics of fiber arrangement are more consistent and have higher uniformity. Fractal intensity reflects the abrupt change of fractal dimension in different scale components, and is used to measure the complexity and randomness of data distribution. Fractal strength is quantified by fitting the curve slope of fractal dimension and scale change. Higher fractal strength indicates that the fiber arrangement is random and there may be significant microscopic changes, while lower fractal strength indicates that the fiber arrangement tends to be stable. Fractal spectrum width and fractal strength jointly represent the complexity and distribution characteristics of fiber arrangement.

Specifically, in the process for comparing the complexity characteristic parameters with a preset standard to determine whether the randomness of the fiber arrangement pattern within the local region is normal, based on historical data and experimental samples, the reasonable range of fractal spectrum width and fractal intensity is established, and the preset standard of complexity characteristic parameters is formed. The preset standard should consider the difference of fiber arrangement in different regions to ensure the wide applicability of the standard.

For example, the reasonable range of fractal spectrum width and fractal intensity can be expressed by upper and lower limits respectively: the fractal spectrum width is [Wₘᵢₙ, Wₘₐₓ] and the fractal intensity is [Sₘᵢₙ, Sₘₐₓ].

If the width of fractal spectrum is within a reasonable range, it means that the multi-scale characteristics of fiber arrangement are normal; if it is beyond the range, there may be abnormal uneven distribution; if the fractal strength is within a reasonable range, it means that the complexity and randomness of fiber arrangement are normal. If it is beyond the range, there may be too smooth or drastic random changes.

When the fractal spectrum width and fractal intensity are within a reasonable range, it is determined that the randomness of fiber arrangement patterns in local areas is normal; If any parameter of fractal spectrum width and fractal intensity is not within a reasonable range, it is determined that the fiber arrangement pattern in the local area is random and abnormal.

In an embodiment, the analyzing a variation trend of the fiber micro-difference indicators over different time sequences by using a nonlinear method based on phase space reconstruction, to determine whether a deviation amplitude of a fiber arrangement of the straw is normal to thereby obtain a second determination result, includes:
arranging the fiber micro-difference indicators corresponding to multiple time points in a preset order to form a fiber micro-difference indicator time series;
mapping the fiber micro-difference indicator time series to a multi-dimensional state vector set based on the phase space reconstruction;
performing a nonlinear analysis method on the multi-dimensional state vector set to extract deviation-related characteristic parameters, wherein the deviation-related characteristic parameters are used to quantify a variation pattern of the fiber arrangement in a time dimension; and
comparing the deviation-related characteristic parameters with a preset reference range to determine whether the deviation amplitude of the fiber arrangement of the straw is normal.

Specifically, in the process for arranging the fiber micro-difference indicators corresponding to multiple time points in a preset order to form a fiber micro-difference indicator time series, values of the fiber differential indicator corresponding to each time point are extracted and arranged in time order to generate the fiber micro-difference indicator time series.

The micro-difference indicator time series is a sequence of data with time as the horizontal axis and the micro-difference indicator value as the vertical axis, characterizing the dynamic properties of fiber arrangement changes over different time sequences. Its length should cover the entire analysis period to ensure it reflects the complete dynamic characteristics of the fiber arrangement. Any missing data points in the time series must be supplemented using interpolation methods to guarantee the completeness of the time series.

Specifically, in the process for mapping the fiber micro-difference indicator time series to a multi-dimensional state vector set based on the phase space reconstruction, based on the micro-difference indicator time series, use the delay coordinate method to map it into a high-dimensional phase space, generating a multidimensional state vector set.

It is assumed that, the micro-difference indicator time series is X(t), a state vector of a time point t is expressed as:

$$V ( t ) = [ X ( t ) , X ( t + τ ) , X ( t + 2 τ ) , … , X ( t + ( A - 1 ) τ ) ]$$

where V(t) represents the state vector at the time point t, X(t) represents a fiber micro-difference indicator at the time point t, τ represents the time delay parameter (used to determine the delay interval of the state vector), and A represents an embedding dimension (used to define the dimension size of the state vector).

V(t) is a specific state vector in the multi-dimensional state vector set, and each V(t) is a part of the multi-dimensional state vector set, which is used to describe the evolution law of time series in high-dimensional space.

Specifically, the selection of time delay parameters is based on the mutual information method. By calculating the mutual information values of time series at different time intervals, the optimal delay value is determined. Specifically, with the increase of time intervals, the correlation between the series gradually weakens and the mutual information values gradually decrease. By detecting the first local minimum point of the mutual information value, the corresponding time interval is selected as the time delay parameter. This method ensures the independence of the mapped state vector in the time dimension and avoids it.

The embedding dimension is determined based on the pseudo nearest neighbor method. By analyzing the embedding characteristics of time series in different dimensions, the optimal embedding dimension is found. The pseudo nearest neighbor method compares the neighboring relationship between a point in a high-dimensional phase space and a point in a low-dimensional space. When the embedding dimension is insufficient, neighboring points will become nonadjacent due to the folding phenomenon, and the embedding dimension will be gradually increased until the pseudo nearest neighbor ratio is less than a set threshold, at which time the corresponding dimension is the embedding dimension.

In an embodiment, the performing a nonlinear analysis method on the multi-dimensional state vector set to extract deviation-related characteristic parameters, wherein the deviation-related characteristic parameters are used to quantify a variation pattern of the fiber arrangement in a time dimension, includes:
calculating a Euclidean distance between state vectors corresponding to adjacent time points as a local deviation distance based on the following formula:

$$B ( t ) = \sqrt{{\sum }_{a = 1}^{A} {( {V}_{a} ( t ) - {V}_{a} ( t - 1 ) )}^{2}}$$

where B(t) represents a local deviation distance at a time point t, Vₐ(t) represents a a-th component of a state vector at the time point t, a represents an index (used to identify different dimensions of the high-dimensional state vectors) of a component in the state vector.

The larger the local deviation distance, the greater the instantaneous variation amplitude of the fiber arrangement.

Specifically, in the process for comparing the deviation-related characteristic parameters with a preset reference range to determine whether the deviation amplitude of the fiber arrangement of the straw is normal, the preset reference range [Bₘᵢₙ, Bₘₐₓ] is set, which is based on a large number of historical data and experimental samples. By analyzing a distribution law of the local deviation distance of fiber arrangement under normal conditions, reasonable upper and lower limits thereof are determined. The preset reference range needs to consider the dynamic change characteristics under different time points, regions or processing conditions to ensure adaptability and accuracy.

When the local deviation distance is within the preset reference range [Bₘᵢₙ, Bₘₐₓ], it means that the instantaneous variation range of fiber arrangement is within a reasonable range and the dynamic characteristics are normal; If it exceeds the preset reference range [Bₘᵢₙ, Bₘₐₓ], it indicates that the deviation amplitude is abnormal, which may be that the dynamic change is too drastic or insufficient, reflecting that there is abnormality in fiber arrangement or measurement error.

When the local deviation distance is within the preset reference range [Bₘᵢₙ, Bₘₐₓ], it is determined that the offset amplitude of the fiber arrangement is normal, otherwise, it is determined that the offset amplitude of the fiber arrangement is abnormal.

In an embodiment, the determining, based on the first determination result and the second determination result, whether a stability of the fiber micro-difference indicators meets a preset requirement, includes:
in response to that the randomness of the fiber arrangement pattern of the straw within the local region is normal and the deviation amplitude of the fiber arrangement of the straw is normal, determining the stability of the fiber micro-difference indicators meeting the preset requirement; otherwise, determining the stability of the fiber micro-difference indicators not meeting the preset requirement.

Specifically, the comprehensive evaluation based on the randomness and deviation amplitude of fiber arrangement mode can fully reflect the stability of fiber micro-difference indicators. The randomness of fiber arrangement mode is used to evaluate the diversity and uniformity of fiber distribution and ensure the reasonable complexity of fiber structure in local areas. The deviation amplitude reflects the stability of fiber arrangement in the process of dynamic change, avoiding too violent or too gentle dynamic fluctuation. Only when randomness and deviation amplitude are in normal state can it be proved that fiber arrangement has reasonable structural characteristics and remains stable in dynamic change, thus ensuring the accuracy of fiber micro-difference indicators. Such comprehensive judgment logic can reduce the possible errors caused by a single evaluation, comprehensively improve the reliability of the indicators, provide scientific basis for subsequent analysis, and avoid inaccuracies caused by abnormal data.

Therefore, when the randomness of fiber arrangement pattern in local area is normal and the deviation amplitude of fiber arrangement is normal, the stability of fiber micro-difference indicators is determined to be up to standard; otherwise, it is determined that the stability of fiber micro-difference indicators is not up to standard.

In an embodiment, the in response to the stability of the fiber micro-difference indicators meeting the preset requirement, comparing the fiber micro-difference indicators with fiber composition reference data to determine whether the fiber micro-difference indicators meet a preset standard; and in response to determining that the fiber micro-difference indicators meet the preset standard, determining nutrition analysis data of the straw, includes:
selecting reference data respectively corresponding to the multiple analysis sub-regions from a preset fiber composition reference database according to attributes of the multiple analysis sub-regions;
comparing the fiber micro-difference indicators in the multiple analysis sub-regions with the selected reference data respectively corresponding to the multiple analysis sub-regions item by item to determine each of the fiber micro-difference indicators meets the preset standard;
in response to all of the fiber micro-difference indicators meet the preset standard, generating the nutrition analysis data of the straw.

Specifically, in the process for selecting reference data respectively corresponding to the multiple analysis sub-regions from a preset fiber composition reference database according to attributes of the multiple analysis sub-regions, the fiber composition reference database is constructed, which is composed of experimental sample data and practical application data, and contains fiber composition parameter ranges from different sources, processing methods and batches. Each data record includes the upper and lower limits of index values such as cellulose content, hemicellulose content and lignin content.

The reference data is filtered according to the attributes of the analysis sub-region (such as fiber source, processing method and batch) to ensure the matching degree. The selection steps are as follows: perfect match filtering: selecting the reference items that are completely consistent with the analysis sub-area; close matching screening: when there are not enough exact matching items, selecting the item with the closest source attribute as reference; and priority screening: if multiple items meet the conditions, selecting optimal reference data according to the source attribute priority (such as batch priority or processing method priority).

In comparing the fiber micro-difference indicator with the selected reference data item by item to judge whether it meets the preset standard, the comparison items include nutritional characteristics such as cellulose content, hemicellulose content and lignin content, and each item has reference upper and lower limits.

For each indicator, it is determined whether the calculated value falls within the range corresponding to the reference data: if the calculated value falls within the upper and lower limits, it is marked as a conforming item; If the calculated value is out of range, it will be marked as nonconformity and the abnormal value will be recorded.

For example, if the reference range of cellulose content is [30, 40] and the calculated value is 35, it is determined to be in conformity; If the calculated value is 45, it is determined as non-conformity.

Comparison is performed on all indicators in the sub-area one by one to generate a set of comparison result data (coincidence/non-coincidence).

Specifically, in the process for in response to all of the fiber micro-difference indicators meet the preset standard, generating the nutrition analysis data of the straw, when the fiber micro-difference indicator of the sub-region meets the reference data range in all comparison items, it is determined to meet the preset standard; If any index does not meet the reference data range, it is determined that it does not meet the preset standard.

For the sub-regions that do not meet the preset standards, it is necessary to record the abnormal items and their corresponding reference data and calculated values, so as to provide a basis for subsequent analysis.

For all the analysis sub-regions that meet the preset standards, the fiber micro-difference indicator values are integrated to generate the comprehensive nutritional characteristics data of the sub-regions. The data integration includes the average value of cellulose content, the total amount of hemicellulose content and the distribution of lignin content.

Based on the comprehensive data of all analysis sub-regions, the total nutritional analysis results of the whole sample are calculated. Global analysis data include average cellulose content, average hemicellulose content, lignin distribution ratio and overall nutritional characteristics.

The generated straw nutrition analysis data are stored in the database for feed formula adjustment or production process optimization. If the sub-regions do not meet the preset standards, the corresponding regions are marked as abnormal regions, prompting further analysis and adjustment.

In an embodiment, the straw includes a corn straw, a wheat straw and a rice straw, and the method further includes: performing the steps in FIG. 1 to determine nutrition analysis data for each of the corn straw, the wheat straw and the rice straw; based on the nutrition analysis data of each of the corn straw, the wheat straw and the rice straw, and a production cycle consisting of a nursing phase, a growing phase, a finishing phase of a livestock (for example, cattle, sheep, or the like), adjusting, by a feeding Specialist, blending ratios of the corn straw, the wheat straw and the rice straw in a diet of the livestock; and feeding the diet with the adjusted blending ratios to the livestock, thereby achieving production goals.

### Embodiment 2

A difference between the embodiment 2 and the embodiment 1 of the present disclosure is that the embodiment 2 presents a system for nutritional analysis of straw feed based on image recognition is provided.

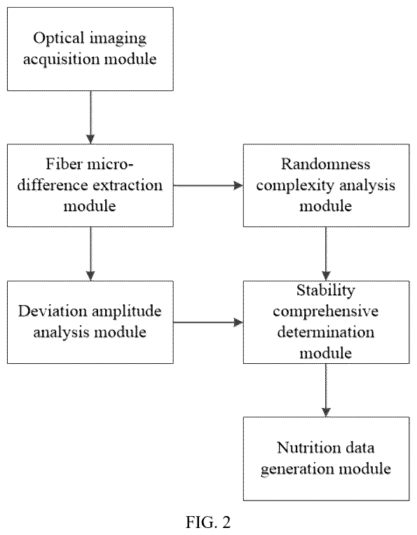

FIG. 2 illustrates a schematic structural view of the system for nutritional analysis of straw feed based on image recognition, which includes: an optical imaging acquisition module, a fiber micro-difference extraction module, a randomness complexity analysis module, a deviation amplitude analysis module, a stability comprehensive determination module, and a nutrition data generation module.

The optical imaging acquisition module is configured to: perform multi-directional optical imaging acquisition on a surface of a straw to obtain straw image data, and divide the straw image data into multiple analysis sub-regions.

The fiber micro-difference extraction module is configured to: perform morphological analysis to extract fiber arrangement information from the multiple analysis sub-regions to enhance fiber texture features, and extract fiber micro-difference indicators based on pixel distribution parameters and neighborhood relationships of the fiber arrangement information.

The randomness complexity analysis module is configured to: perform complexity analysis on distribution characteristics of the fiber micro-difference indicators through image decomposition based on a multifractal model, to determine whether randomness of a fiber arrangement pattern of the straw within a local region is normal to thereby obtain a first determination result.

The deviation amplitude analysis module is configured to: analyze a variation trend of the fiber micro-difference indicators over different time sequences by using a nonlinear method based on phase space reconstruction, to determine whether a deviation amplitude of a fiber arrangement of the straw is normal to thereby obtain a second determination result.

The stability comprehensive determination module is configured to: determine, based on the first determination result and the second determination result, whether a stability of the fiber micro-difference indicators meets a preset requirement.

The nutrition data generation module is configured to: in response to the stability of the fiber micro-difference indicators meeting the preset requirement, compare the fiber micro-difference indicators with fiber composition reference data to determine whether the fiber micro-difference indicators meet a preset standard; and in response to determining that the fiber micro-difference indicators meet the preset standard, determine nutrition analysis data of the straw.

In an embodiment, each of the optical imaging acquisition module, the fiber micro-difference extraction module, the randomness complexity analysis module, the deviation amplitude analysis module, the stability comprehensive determination module, and the nutrition data generation module is embodied by at least one processor and at least one memory coupled to the at least one processor, and the at least one memory stores computer programs executable by the at least one processor.

The formulas above are dimensionless and use only their numerical values. Each formula was obtained by collecting large datasets and performing software simulations to approximate real-world conditions as closely as possible. The preset parameters and thresholds in the formulas shall be chosen by a person skilled in the art according to actual circumstances.

The embodiments described may be implemented in full or in part by software, hardware, firmware, or any arbitrary combination thereof. When implemented in software, the embodiments may be realized wholly or partly in the form of a computer-program product. The computer-program product comprises one or more computer instructions or programs. When such instructions or programs are loaded into and executed on a computer, they generate—wholly or partly—the flows or functions described in the present embodiments. The computer may be a general-purpose computer, a special-purpose computer, a computer network, or any other programmable device. The computer instructions may reside in a computer-readable storage medium, or may be transmitted from one computer-readable storage medium to another, e.g., from a website, computer, server, or data center to another website, computer, server, or data center over a wired or wireless medium such as infrared, radio, or microwave. The computer-readable storage medium may be any medium accessible by a computer, or a server or data-storage device (e.g., a data center) that contains one or more such media. Suitable media include magnetic media (e.g., floppy disks, hard disks, magnetic tape), optical media (e.g., DVDs), and semiconductor media such as solid-state drives.

A person of ordinary skill in the art will appreciate that the modules and algorithmic steps illustrated in the disclosed embodiments may be implemented in electronic hardware, or in a combination of computer software and electronic hardware. Whether a function is performed in hardware or software depends on the specific application and design constraints of the technical solution. A professional may employ different methods for each particular application to achieve the described functionality, but such implementations should not be regarded as departing from the scope of the present application.

For brevity and clarity, the detailed working procedures of the systems, apparatuses, and modules described above are not repeated herein; they may be understood by reference to the corresponding method embodiments previously set forth.

It should be understood that the systems, apparatuses, and methods disclosed in the various embodiments of the present application may be realized in other ways. For example, the apparatus embodiments described are merely illustrative; the division of modules is only a logical functional division, and other divisions may be adopted in practice. Multiple modules or components may be combined or integrated into another system, or some features may be omitted or not executed. Moreover, the coupling, direct coupling, or communication connection shown or discussed may be accomplished through some interface, device, or module, and may be electrical, mechanical, or of any other form.

The modules described as separate components may or may not be physically separate, and the components shown as modules may or may not be physical modules. They may be located in one place or distributed across multiple network modules. Some or all of the modules may be selected according to actual needs to achieve the objectives of the present embodiments.

Furthermore, the functional modules in the various embodiments of the present application may be integrated into one processing module, or they may exist separately in hardware, or two or more modules may be integrated into one module.

When the functions are implemented in the form of software functional modules and sold or used as standalone products, they may be stored in a computer-readable storage medium. Based on this understanding, the technical solutions of the present application—essentially, or the parts that contribute to the prior art—may be embodied in the form of a software product. The computer software product is stored in a storage medium and includes several instructions for causing a computer device (which may be a personal computer, a server, a network device, etc.) to perform all or part of the steps of the methods described in the various embodiments of the present application. The storage media mentioned above include U-disks, mobile hard disks, read-only memory (ROM), random-access memory (RAM), magnetic disks, optical discs, and any other media capable of storing program code.

The foregoing descriptions are merely specific implementations of the present application. The protection scope of the present application is not limited thereto; any person skilled in the art could readily conceive of changes or replacements within the technical scope disclosed herein, which shall be encompassed within the protection scope of the present application. Therefore, the protection scope of the present application shall be subject to the claims.

Finally, the above embodiments are only preferred examples of the present disclosure and are not intended to limit the disclosure. Any modifications, equivalent replacements, or improvements made within the spirit and principles of the present disclosure shall be included within its protection scope.

What is claimed is:

1. A method for nutritional analysis of straw feed based on image recognition, comprising:
performing multi-directional optical imaging acquisition on a surface of a straw to obtain straw image data, and dividing the straw image data into multiple analysis sub-regions;
performing morphological analysis to extract fiber arrangement information from the multiple analysis sub-regions to enhance fiber texture features, and extracting fiber micro-difference indicators based on pixel distribution parameters and neighborhood relationships of the fiber arrangement information;
performing complexity analysis on distribution characteristics of the fiber micro-difference indicators through image decomposition based on a multifractal model, to determine whether randomness of a fiber arrangement pattern of the straw within a local region is normal to thereby obtain a first determination result;
analyzing a variation trend of the fiber micro-difference indicators over different time sequences by using a nonlinear method based on phase space reconstruction, to determine whether a deviation amplitude of a fiber arrangement of the straw is normal to thereby obtain a second determination result;
determining, based on the first determination result and the second determination result, whether a stability of the fiber micro-difference indicators meets a preset requirement; and
in response to the stability of the fiber micro-difference indicators meeting the preset requirement, comparing the fiber micro-difference indicators with fiber composition reference data to determine whether the fiber micro-difference indicators meet a preset standard; and in response to determining that the fiber micro-difference indicators meet the preset standard, determining nutrition analysis data of the straw.

2. The method for nutritional analysis of straw feed based on image recognition as claimed in claim 1, wherein the performing multi-directional optical imaging acquisition on a surface of a straw to obtain straw image data, and dividing the straw image data into multiple analysis sub-regions, comprises:
arranging multiple optical imaging devices on the surface of the straw, and configuring multiple sets of light sources, and obtaining the straw image data from multiple directions by adjusting focal lengths and shooting parameters of the multiple optical imaging devices; and
storing and pre-processing the straw image data from the multiple directions to obtain a preprocessed image set, and decomposing the preprocessed image set into the multiple analysis sub-regions according to a preset division criterion.

3. The method for nutritional analysis of straw feed based on image recognition as claimed in claim 2, wherein the performing morphological analysis to extract fiber arrangement information from the multiple analysis sub-regions to enhance fiber texture features, and extracting fiber micro-difference indicators based on pixel distribution parameters and neighborhood relationships of the fiber arrangement information, comprises:
performing the morphological analysis on the straw image data within the multiple analysis sub-regions, and enhancing the fiber texture features by selecting multi-scale structural elements, wherein the multi-scale structural elements are configured to adapt to fiber textures of different thicknesses and orientations;
performing quantitative analysis on the fiber arrangement information in the multiple analysis sub-regions based on the pixel distribution parameters, wherein the pixel distribution parameters are obtained by calculating gray value variation characteristics of the local region;
analyzing, based on spatial correlation between local pixels and surrounding pixels of the local pixels, the neighborhood relationships of the fiber arrangement information to extract neighborhood characteristic parameters of the fiber arrangement of the straw; and
extracting the fiber micro-difference indicators based on the pixel distribution parameters and the neighborhood characteristic parameters, wherein the fiber micro-difference indicators are used to characterize micro-difference characteristics of the fiber arrangement of the straw.

4. The method for nutritional analysis of straw feed based on image recognition as claimed in claim 3, wherein the performing complexity analysis on distribution characteristics of the fiber micro-difference indicators through image decomposition based on a multifractal model, to determine whether randomness of a fiber arrangement pattern of the straw within a local region is normal to thereby obtain a first determination result, comprises:
generating a two-dimensional distribution matrix based on a spatial coordinate distribution of the fiber micro-difference indicators in the multiple analysis sub-regions;
decomposing, based on the multifractal model, the two-dimensional distribution matrix into multiple scale components;
calculating fractal dimensions respectively corresponding to the multiple scale components to quantify complexities of the fiber arrangement at different scales in the two-dimensional distribution matrix;
extracting complexity characteristic parameters for characterizing the randomness of the fiber arrangement pattern according to a distribution pattern of the fractal dimensions across the different scales, wherein the complexity characteristic parameters comprise a fractal spectrum width and a fractal intensity; and
comparing the complexity characteristic parameters with a preset standard to determine whether the randomness of the fiber arrangement pattern within the local region is normal.

5. The method for nutritional analysis of straw feed based on image recognition as claimed in claim 4, wherein the analyzing a variation trend of the fiber micro-difference indicators over different time sequences by using a nonlinear method based on phase space reconstruction, to determine whether a deviation amplitude of a fiber arrangement of the straw is normal to thereby obtain a second determination result, comprises:
arranging the fiber micro-difference indicators corresponding to multiple time points in a preset order to form a fiber micro-difference indicator time series;
mapping the fiber micro-difference indicator time series to a multi-dimensional state vector set based on the phase space reconstruction;
performing a nonlinear analysis method on the multi-dimensional state vector set to extract deviation-related characteristic parameters, wherein the deviation-related characteristic parameters are used to quantify a variation pattern of the fiber arrangement in a time dimension; and
comparing the deviation-related characteristic parameters with a preset reference range to determine whether the deviation amplitude of the fiber arrangement of the straw is normal.

6. The method for nutritional analysis of straw feed based on image recognition as claimed in claim 5, wherein the performing a nonlinear analysis method on the multi-dimensional state vector set to extract deviation-related characteristic parameters, wherein the deviation-related characteristic parameters are used to quantify a variation pattern of the fiber arrangement in a time dimension, comprises:
calculating a Euclidean distance between state vectors corresponding to adjacent time points as a local deviation distance based on the following formula:
$$B ( t ) = \sqrt{{\sum }_{a = 1}^{A} {( {V}_{a} ( t ) - {V}_{a} ( t - 1 ) )}^{2}}$$
where B(t) represents a local deviation distance at a time point t, Vₐ(t) represents an a-th component of a state vector at time point t, a represents an index of a component in the state vector, and A represents an embedding dimension.

7. The method for nutritional analysis of straw feed based on image recognition as claimed in claim 6, wherein the determining, based on the first determination result and the second determination result, whether a stability of the fiber micro-difference indicators meets a preset requirement, comprises:
in response to that the randomness of the fiber arrangement pattern of the straw within the local region is normal and the deviation amplitude of the fiber arrangement of the straw is normal, determining the stability of the fiber micro-difference indicators meeting the preset requirement; otherwise, determining the stability of the fiber micro-difference indicators not meeting the preset requirement.

8. The method for nutritional analysis of straw feed based on image recognition as claimed in claim 7, wherein the in response to the stability of the fiber micro-difference indicators meeting the preset requirement, comparing the fiber micro-difference indicators with fiber composition reference data to determine whether the fiber micro-difference indicators meet a preset standard; and in response to determining that the fiber micro-difference indicators meet the preset standard, determining nutrition analysis data of the straw, comprises:
selecting reference data respectively corresponding to the multiple analysis sub-regions from a preset fiber composition reference database according to attributes of the multiple analysis sub-regions;
comparing the fiber micro-difference indicators in the multiple analysis sub-regions with the selected reference data respectively corresponding to the multiple analysis sub-regions item by item to determine each of the fiber micro-difference indicators meets the preset standard; and
in response to all of the fiber micro-difference indicators meet the preset standard, generating the nutrition analysis data of the straw.

9. A system for nutritional analysis of straw feed based on image recognition, used to implement the method for nutritional analysis of straw feed based on image recognition as claimed in any one of claims 1-8, and the system comprising:
an optical imaging acquisition module, configured to: perform multi-directional optical imaging acquisition on a surface of a straw to obtain straw image data, and divide the straw image data into multiple analysis sub-regions;
a fiber micro-difference extraction module, configured to: perform morphological analysis to extract fiber arrangement information from the multiple analysis sub-regions to enhance fiber texture features, and extract fiber micro-difference indicators based on pixel distribution parameters and neighborhood relationships of the fiber arrangement information;
a randomness complexity analysis module, configured to: perform complexity analysis on distribution characteristics of the fiber micro-difference indicators through image decomposition based on a multifractal model, to determine whether randomness of a fiber arrangement pattern of the straw within a local region is normal to thereby obtain a first determination result;
a deviation amplitude analysis module, configured to: analyze a variation trend of the fiber micro-difference indicators over different time sequences by using a nonlinear method based on phase space reconstruction, to determine whether a deviation amplitude of a fiber arrangement of the straw is normal to thereby obtain a second determination result;
a stability comprehensive determination module, configured to: determine, based on the first determination result and the second determination result, whether a stability of the fiber micro-difference indicators meets a preset requirement; and
a nutrition data generation module, configured to: in response to the stability of the fiber micro-difference indicators meeting the preset requirement, compare the fiber micro-difference indicators with fiber composition reference data to determine whether the fiber micro-difference indicators meet a preset standard; and in response to determining that the fiber micro-difference indicators meet the preset standard, determine nutrition analysis data of the straw.
